(19) United States
(12) Patent Application Publication
(10) Pub. No.: US 2010/0167253 A1
(43) Pub. Date: Jul. 1, 2010

(54) Surgical training simulator

(75) Inventors: Donncha Ryan, Harold's Cross (IE); Claire Staunton, Co. Dublin (IE); Fiona Slevin, Ranelagh (IE); Derek Cassidy, Kilmanhim (IE); Nicolas Sezille, Blackrock (IE)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Haptica Ltd.

(21) Appl. No.: 12/318,600

(22) Filed: Dec. 31, 2008

(51) Int. Cl. G09B 23/30

(52) U.S. Cl. 434/272

(57) ABSTRACT

A surgical simulator is disclosed. The simulator includes at least one tracking system configured to track movement within a body form, including movement of an instrument located partially within the body form, and a computer receiving data from the tracking system and outputting data to a display. A display displays a virtual background including a virtual image of at least a portion of the instrument, virtual movement of the instrument, and a virtual image of at least one organ. The simulator also includes a physical model corresponding to the at least one organ and located within the body form, the physical model providing haptic feedback when contacted by the instrument.

### TECHNICAL FIELD

The present disclosure is directed to a surgical training simulator, and more particularly, a surgical training simulator having non-anatomical physical models for providing haptic feedback.

### BACKGROUND

Surgical simulators may provide simulation and training of actual surgical procedures and situations. The surgical simulators may employ virtual reality to simulate the surgical environment and the procedure itself. In such virtual reality surgical simulators, the instruments may be designed to give haptic feedback. In addition or alternatively, surgical simulators may include anatomical models that provide haptic feedback to a user, simulating physical interactions with the virtual surgical environment.

The surgical simulator of the present disclosure is directed towards providing an improved surgical training simulator having a more practical system for providing haptic feedback of a virtual surgical environment.

### SUMMARY OF THE DISCLOSURE

One aspect of the present disclosure is directed to a surgical training simulator. The simulator may include a simulated body form. The simulator may also include at least one tracking system configured to track movement within the body form, including movement of an instrument located partially within the body form, and a computer receiving data from the tracking system and outputting data to a display. A display may display a virtual background including a virtual image of at least a portion of the instrument, virtual movement of the instrument, and a virtual image of at least one organ. The simulator may also include a physical model corresponding to the at least one organ and located within the body form, the physical model providing haptic feedback when contacted by the instrument.

Another aspect of the present disclosure is directed to a surgical simulator. The simulator may include a simulated body form and a physical model corresponding to at least one organ and located within the body form. The simulator may also include at least one tracking system configured to track movement within the body form, including movement of an instrument located partially within the body form, and a computer receiving data from the tracking system and outputting data to a display. The simulator may also include a display displaying a virtual background including a virtual image of at least a portion of the instrument, virtual movement of the instrument, and a virtual image of the at least one organ based on the physical model, such that the physical model is used solely for haptic feedback.

Another aspect of the present disclosure is directed to a surgical simulator. The simulator may include a simulated body form and a physical model corresponding to a first organ and located within the body form. The simulator may also include at least one tracking system configured to track movement within the body form, including movement of an instrument located partially within the body form, and a computer receiving data from the tracking system and outputting data to a display. The simulator may also include a display displaying a virtual background including a virtual image of at least a portion of the instrument, virtual movement of the instrument, and virtual images of at least the first organ and a second organ, the physical model including a non-anatomical haptic model.

### BRIEF DESCRIPTION OF THE DRAWINGS

FIG. 1 is a perspective view from above showing a surgical training device in use according to an exemplary disclosed embodiment;

FIG. 2 is a cross-sectional elevation view of a body form apparatus of the surgical training simulator according to an exemplary disclosed embodiment;

FIG. 3 is a cross-sectional plan view of a body form apparatus of the surgical training simulator according to an exemplary disclosed embodiment;

FIG. 4 is a flow diagram illustrating an image processing operation of the surgical training simulator according to an exemplary disclosed embodiment;

FIG. 5 is a cross-sectional elevation view of a body form apparatus of the surgical training simulator according to an exemplary disclosed embodiment; and

FIG. 6 is a cross-sectional elevation view of a body form apparatus of the surgical training simulator according to an exemplary disclosed embodiment.

### DETAILED DESCRIPTION

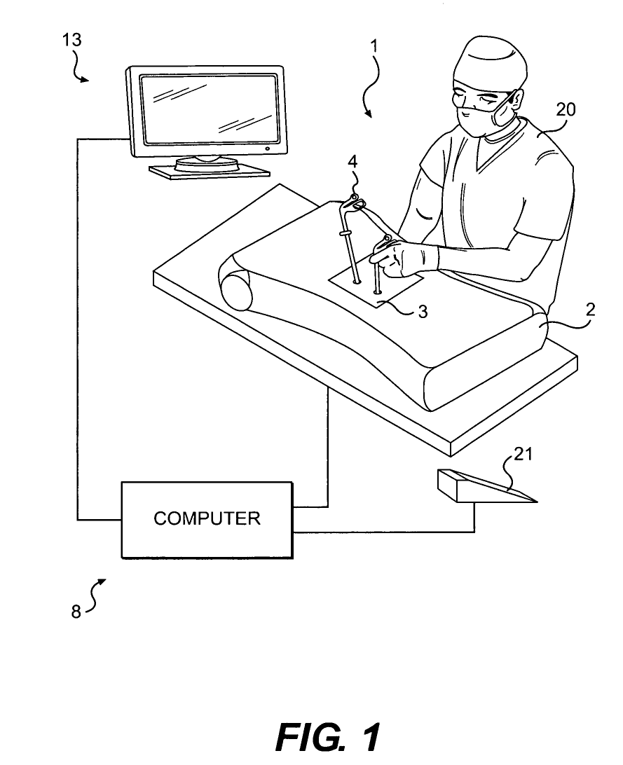

As shown in the exemplary embodiments of FIGS. 1 to 3, a surgical training simulator 1 may include a simulated body form 2 having a panel 3 of flexible material configured to simulate skin. Instrument 4 may extend through small apertures of panel 3 and may be at least partially within body form 2. Additionally or alternatively, instrument 4 may be inserted through other pre-existing openings on body form 2, or instrument 4 may puncture body form 2 to create the opening. Instrument 4 may be, for example, a laporoscopic instrument, an endoscopic instrument, or any other conventional type of surgical instrument. Also as shown in FIG. 1, surgical simulator 1 may include a computer 8 and a display 13. Computer 8 may be configured to receive simulation data from body form 2 and may use the received data to provide simulation data to display 13 to be viewed by a user 20 of surgical training simulator 1. Instrument 4 may be free from any connection with computer 8. Additionally, surgical training simulator 1 may include a foot pedal 21 for controlling aspects of surgical training simulator 1.

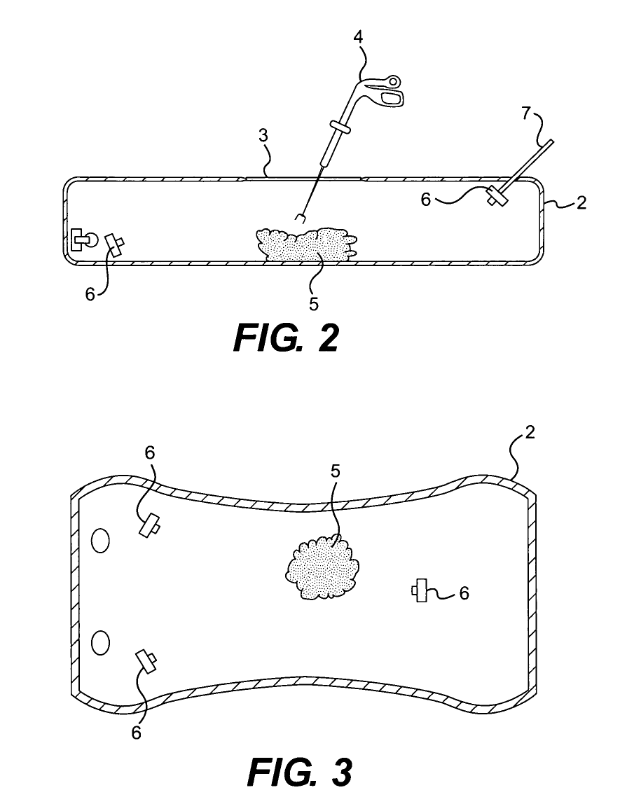

As shown in FIGS. 2 and 3, at least one physical model 5 may be disposed within body form 2 and at least one tracking system 6 may be positioned within body form 2 and may be configured to track movement within body form 2. Tracking system 6 may include, for example, at least one camera. In one exemplary embodiment, two tracking systems 6 may be mounted at the top end and one tracking system 6 at the lower end of body form 2 to capture perspective views of the space in which instrument 4 and physical model 5 are located and moved. Tracking system 6 may also include an adjustment handle 7 protruding from body form 2. The location of tracking system 6 may be different and the number of tracking systems 6 within body form 2 may vary depending upon, among other things, the desired accuracy of instrument 4 tracking. While only one physical model 5 is shown in FIG. 2, it is understood that numerous physical models 5 may be included within body form 2 and tracked by at least one tracking system 6.

Referring back to FIG. 1, computer 8 may be associated with and receive simulation data from tracking system 6. Data and images of movement and position of physical model 5 and instrument 4 and interaction between instrument 4 and physical model 5 may be received by computer 8. Computer 8 may employ stereo triangulation techniques such as that described in U.S. Patent Application Publication No. 2005/0084833 A1 to track three-dimensional position data of instrument 4 and physical model 5. The entire contents of U.S. Patent Application Publication No. 2005/0084833 A1 are herein incorporated by reference. It is understood, however, that any conventional tracking system may be used to determine the position of instrument 4 and physical model 5.

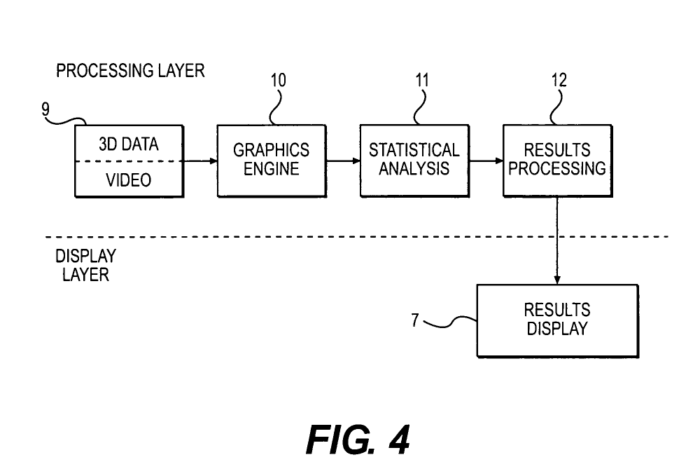

Referring to FIG. 4, three-dimensional position data 9 of instrument 4 and physical model 5 may be received from the tracking system 6 and fed into a graphics engine 10, which may feed into a statistical engine 11 which extracts a number of measures, in turn feeding into a results processing function 12 which may use the measures from the statistical engine 11 to generate a set of metrics that score the performance of user 20 of surgical training simulator 1 according to a set of criteria. In this mode of operation, computer 8 may output simulation data to a display 13, wherein display 13 may not display actual images within body form 2, but instead a virtual background including a virtual image of at least a portion of instrument 4, virtual movement of instrument 4, and a virtual image of at least one organ. The virtual background may represent physical model 5 as an anatomically correct visual simulation of the at least one organ. The three-dimensional position data 9 of instrument 4 and physical model 5 tracked within body form 2 may reflect the positions of the virtual instrument 4 and the virtual organ within the virtual background and may control the position and orientation of the viewpoint of user 20.

The graphics engine 10 may render physical model 5 as a virtual simulation of the at least one organ having anatomically correct space, shape, lighting, and texture attributes. The graphics engine 10 may simulate visual movement of the at least one organ as physical model 5 is physically moved by instrument 4 or user 20. Therefore, physical manipulation of physical model 5 may provide haptic feedback for user 20 as well as a basis for visual simulation of the virtual organ. A scene manager of graphics engine 10 may, by default, render a static scene of the static organ viewed from the position of tracking system 6. A view manger of graphics engine 10 may accept inputs indicating a desired tracking system 6 angle. Therefore, the view of physical model 5, and thus, the virtual organ may be displayed on display 13 from any selected tracking system 6 angle as required by user 20 and/or the application. The graphics engine 10 may also render instrument 4 as a virtual instrument and simulate virtual movement of instrument 4 according to the three-dimensional position data 9 of instrument 4.

The three-dimensional position data 9 of instrument 4 and physical model 5 within body form 2 may correspond to positions within the virtual background displayed on display 13. A stream of three-dimensional position data 9 may allow the movements of instrument 4 and physical model 5 to be accurately simulated as virtual movements of the virtual instrument and the at least one organ. Within body form 2, instrument 4 may interact with physical model 5 with actions such as grasping, cutting, suturing, or any other conventional surgical procedure. Therefore, the actual interactions between instrument 4 or user 20 and physical model 5 within body form 2 may be simulated as virtual interactions between the virtual instrument and the at least one organ.

As discussed above, physical model 5 may provide haptic feedback to simulate at least one organ. Haptic feedback from physical model 5 may simulate physical characteristics of the organ and may be based on a resistance from the physical model 5. Resistance to compression of physical model 5 may provide haptic feedback for user 20 which may indicate physical attributes of the organ. Such haptic feedback may be provided from physical model 5 when contacted by instrument 4 and may be matched with movement of virtual images on display 13. For example, user 20 may manipulate instrument 4 within body form 2 and may identify an organ based on the virtual background displayed on display 13 and also by compressing physical model 5, i.e. the physical representation, of the organ. The degree of resistance to compression or compliance of physical model 5 may mimic that of the actual bodily organ but may also vary depending on the particular bodily organ that may be simulated. Alternatively, haptic feedback from physical model 5 may simulate textural characteristics of the organ based on frictional resistance on a surface of physical model 5. Protuberances and dips to the surface of physical model 5 may also provide haptic feedback of the textural characteristics of the organ.

Because haptic feedback of the at least one organ is based on resistance from physical model 5, the haptic feedback of the simulated organ may be delivered through instrument 4 to user 20. Therefore, modifications of instrument 4 to mimic haptic feedback are not required and actual surgical instruments may be employed, and a more realistic surgical simulation may be provided for user 20.

Employing physical model 5 may also provide modularity for surgical simulator 1. Physical model 5 may be interchangeable with a different physical model 5 to provide haptic feedback for a different simulated organ. Alternatively, a single physical model 5 may simulate a variety of organs having similar physical attributes. In addition, surgical training simulator 1 may include at least a second physical model representing a second organ.

Additional simulated organs may be added and removed from surgical training simulator 1. The organ physically represented by physical model 5 and virtually simulated on display 13 may be the only anatomical image displayed. Alternatively, additional virtual images of organs and other anatomical structures having no physical representation within body form 2 may be displayed on display 13. For example, physical model 5 located within body form 2 may correspond to a first organ. Surgical simulator 1 may display the first organ and an additional organ on display 13. The first organ may solely provide haptic feedback for user 20 based on physical model 5, whereas the additional organ may solely provide a visual simulation. When user 20 maneuvers instrument 4 based on the virtual background displayed on display 13, user 20 may experience haptic feedback through instrument 4 as virtual instrument virtually contacts the first organ. However, user 20 will experience no haptic response when the virtual instrument virtually contacts the additional organ because a physical representation of the additional organ is absent from body form 2.

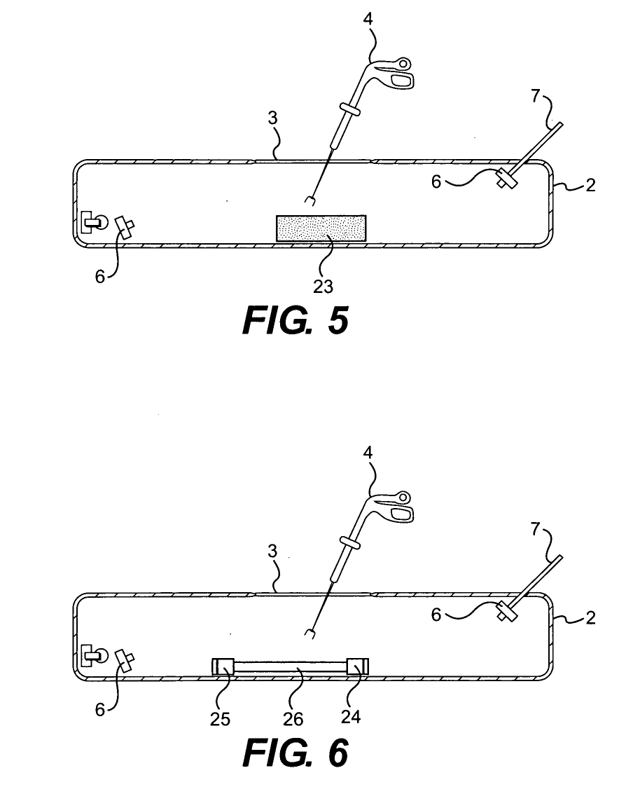

As discussed above, the virtual image of the at least one organ displayed on display 13 may be based upon physical model 5. The only representation of physical model 5 on display 13 may be the virtual image of the at least one organ. In particular, actual pictures of physical model 5 located within body form 2 need not be displayed on display 13, and thus, user 20 may not be visually exposed to physical model 5 during simulation of surgical simulator 1. In view of this, physical model 5 may be employed strictly for haptic feedback, and thus, surgical simulator 1 may divorce itself from employing models which are visually and anatomically correct. Because physical model 5 may be displayed solely as the virtual image of the organ, the visual anatomical features of the at least one organ may not be necessary attributes of physical model 5. Surgical simulator 1 may thus employ a wide range of common, cost-effective materials for physical model 5, such as sponges, plastic tubing, foamed bodies, or latex bodies, that mimic haptic attributes of the at least one organ but are not necessarily visually and anatomically accurate. For example, as shown in FIGS. 5 and 6, sponges 23 generally shaped like a liver may be included in body form 2 (FIG. 5); and plastic tubing 26 of various sizes may be included in body form 2 representing veins, arteries, and/or colon portions (FIG. 6). Such physical models 5 that are not configured to visually represent an organ but are configured to provide appropriate haptic feedback are referred to as non-anatomical haptic models.

Also as shown in FIG. 6, surgical simulator 1 may be configured to regenerate physical model 5 within body form 2. A cartridge 24 or a dispensing apparatus may dispense a new physical model 5 into body form 2 and a used physical model 5 may be discarded into a disposal unit 25. For example, cartridge 24 may dispense a plastic tubing 26 representing an artery or a colon. Once a surgical simulation has exhausted the use of the tubular member, for example, by repeated physical manipulation by instrument 4, it may be urged and discarded into disposal unit 25, with the urging forcing a new plastic tubing 26 from cartridge 24 into body form 2.

Computer 8 may also employ a blending function and a distance learning arrangement such as those described in U.S. Patent Application Publication No. 2005/0084833 A1 for demonstrating surgical training techniques of surgical training simulator 1 for user 20.

### INDUSTRIAL APPLICABILITY

The disclosed surgical simulator 1 may provide enhanced simulation and training of actual surgical procedures and situations. The virtual background, having virtual images of instrument 4 and at least one organ based on physical model 5, may deliver visual simulation to user 20, while resistance based on physical model 5 may provide haptic feedback simulating physical characteristics of the organ.

In beginning the surgical simulation, user 20 may insert instruments 4, such as any standard surgical instrument, into body form 2. The inners of body form 2 are displayed as the virtual background on display 13, thereby, providing user 20 visual guidance and simulation of the surgical procedure. As user 20 maneuvers instrument 4 within body form 2, a virtual organ may be visually identified on display 13, and also physically identified by contact with physical model 5, which is the physical representation of the virtual organ. User 20 may physically interact and manipulate physical model 5 which may be converted and displayed as virtual organ manipulations and interactions on display 13. Therefore, surgical simulator 1 may provide an accurate visual simulation of a simulated surgical procedure with haptic feedback.

Furthermore, because physical model 5 may be visually presented strictly as the virtual image of the at least one organ, the anatomical features of the at least one organ may not be necessary attributes of physical model 5. Therefore, surgical simulator 1 may be capable of employing a wide range of common, cost-effective materials for those non-anatomical haptic models. In addition, since the source of the haptic feedback of the simulated organ is from physical model 5, costly modifications to the system, in particular instrument 4, may be avoided. Thus, actual surgical instruments and tools may be employed with the surgical simulator 1, enhancing the reality and practicality of the simulation for user 20.

It will be apparent to those skilled in the art that various modifications and variations can be made to the surgical simulator of the present disclosure without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being indicated by the following claims.

What is claimed is:

1. A surgical training simulator, comprising:
a simulated body form;
at least one tracking system configured to track movement within the body form, including movement of an instrument located partially within the body form;
a computer receiving data from the tracking system and outputting data to a display;
a display displaying a virtual background including a virtual image of at least a portion of the instrument, virtual movement of the instrument, and a virtual image of at least one organ; and
a physical model representing the at least one organ and located within the body form, the physical model providing haptic feedback when contacted by the instrument.

2. The surgical simulator of claim 1, wherein the physical model is a non-anatomical haptic model.

3. The surgical simulator of claim 2, wherein the non-anatomical haptic model includes one of a sponge or a plastic tubing.

4. The surgical simulator of claim 1, wherein the haptic feedback provided by the physical model is matched with movement of the virtual image on the display.

5. The surgical simulator of claim 1, wherein the haptic feedback provided by the physical model is based on resistance from the physical model.

6. The surgical simulator of claim 1, wherein the physical model is a first physical model representing a first organ and the surgical training simulator including at least a second physical model representing a second organ.

7. The surgical simulator of claim 1, wherein the tracking system includes a plurality of cameras.

8. The surgical simulator of claim 1, wherein the instrument is free from any connection with the computer.

9. The surgical simulator of claim 1, wherein the surgical simulator is configured to regenerate the physical model within the body form.

10. A surgical simulator, comprising:
a simulated body form;
a physical model corresponding to at least one organ and located within the body form;
at least one tracking system configured to track movement within the body form, including movement of an instrument located partially within the body form;
a computer receiving data from the tracking system and outputting data to a display; and
a display displaying a virtual background including a virtual image of at least a portion of the instrument, virtual movement of the instrument, and a virtual image of the at least one organ based on the physical model, such that the physical model is used solely for haptic feedback.

11. The surgical simulator of claim 10, wherein the physical model is a non-anatomical haptic model.

12. The surgical simulator of claim 11, wherein the non-anatomical haptic model includes one of a sponge or a plastic tubing.

13. The surgical simulator of claim 10, wherein the haptic feedback provided by the physical model is matched with movement of the virtual image on the display.

14. The surgical simulator of claim 10, wherein the haptic feedback provided by the physical model is based on resistance from the physical model.

15. The surgical simulator of claim 10, wherein the physical model is a first physical model representing a first organ and the surgical training simulator including at least a second physical model representing a second organ.

16. The surgical simulator of claim 10, wherein the tracking system includes a plurality of cameras.

17. The surgical simulator of claim 10, wherein the instrument is free from any connection with the computer.

18. The surgical simulator of claim 10, wherein the surgical simulator is configured to regenerate the physical model within the body form.

19. A surgical simulator, comprising:
a simulated body form;
a physical model corresponding to a first organ and located within the body form;
at least one tracking system configured to track movement within the body form, including movement of an instrument located partially within the body form;
a computer receiving data from the tracking system and outputting data to a display; and
a display displaying a virtual background including a virtual image of at least a portion of the instrument, virtual movement of the instrument, and virtual images of at least the first organ and a second organ, the physical model including a non-anatomical haptic model.

20. The surgical simulator of claim 19, wherein the non-anatomical haptic model includes one of a sponge or a plastic tubing.

21. The surgical simulator of claim 20, wherein the non-anatomical haptic model is configured to provide haptic feedback matched with movement of the virtual image on the display.

22. The surgical simulator of claim 21, wherein the haptic feedback is based on resistance from the physical model.

23. The surgical simulator of claim 19, wherein the tracking system includes a plurality of cameras.

24. The surgical simulator of claim 19, wherein the instrument is free from any connection with the computer.

25. The surgical simulator of claim 19, wherein the surgical simulator is configured to regenerate the physical model within the body form.
